(19) United States
(12) Patent Application Publication
(10) Pub. No.: US 2026/0252537 A1
(43) Pub. Date: Aug. 27, 2026

(54) SYSTEM AND METHOD FOR CONSOLIDATION AND ANALYSIS OF DATA REPOSITORIES VIA A WEB-BASED TOOL TO AUTOMATE CONTRIBUTION MECHANISMS

(71) Applicant: BANK OF AMERICA CORPORATION, Charlotte, NC (US)

(72) Inventors: Brian D. Ma, Manalapan, NJ (US); Regina Ilashchuk, East Brunswick, NJ (US); Lisa Marie Ricci, Groton, MA (US); Drew M. Smith, Norfolk, MA (US)

(73) Assignee: BANK OF AMERICA CORPORATION, Charlotte, NC (US)

(21) Appl. No.: 19/064,992

(22) Filed: Feb. 27, 2025

(51) Int. Cl. G06F 16/215; G06F 9/451

(52) U.S. Cl. CPC G06F 16/215; G06F 9/451

(57) ABSTRACT

Systems, computer program products, and methods are described herein for consolidation and analysis of data repositories via a web-based tool to automate contribution mechanisms. The present disclosure is configured to: receive a set of data repositories associated with a user wherein an individual data repository within the set comprises a dataset; consolidate datasets within the set of data repositories; calculate, via a web-based tool, a configuration from consolidated datasets based on predefined criteria configured by the user; and populate an interface using the configuration calculated from the web-based tool.

### TECHNOLOGICAL FIELD

Example embodiments of the present disclosure relate to consolidation and analysis of data repositories via a web-based tool to automate contribution mechanisms.

### BACKGROUND

Manual input of data from data repositories may cause misappropriations and may be difficult to align with a configuration.

Applicant has identified a number of deficiencies and problems associated with consolidation and analysis of data repositories via a web-based tool to automate contribution mechanisms. Through applied effort, ingenuity, and innovation, many of these identified problems have been solved by developing solutions that are included in embodiments of the present disclosure, many examples of which are described in detail herein.

### BRIEF SUMMARY

Systems, methods, and computer program products are provided for consolidation and analysis of data repositories via a web-based tool to automate contribution mechanisms. In one aspect, a system for consolidation and analysis of data repositories via a web-based tool to automate contribution mechanisms is provided. The system may include a processing device, a non-transitory storage device containing instructions when executed by the processing device, causes the processing device to perform the steps of: receive a set of data repositories associated with a user wherein an individual data repository within the set comprises a dataset; consolidate datasets within the set of data repositories; calculate, via a web-based tool, a configuration from consolidated datasets based on predefined criteria configured by the user; and populate an interface using the configuration calculated from the web-based tool.

In some embodiments, the at least one processing device is further configured to recommend adjustment of datasets within the set of data repositories to align with predefined criteria.

In some embodiments, the at least one processing device is further configured to recommend adjustment of datasets within the set of data repositories via a resource exchange to align with predefined criteria.

In some embodiments, predefined criteria are adjustable by the user.

In some embodiments, the web-based tool at least partially utilizes a machine learning model to calculate the configuration.

In some embodiments, a plurality of configurations are calculated via the web-based tool based on predefined criteria configured by the user.

In some embodiments, predefined criteria are updated on a predetermined schedule.

In another aspect, a computer program product for consolidation and analysis of data repositories via a web-based tool to automate contribution mechanisms is presented. The computer program product comprising at least one non-transitory computer-readable medium having computer-readable program code portions embodied therein, the computer-readable program code portions which when executed by a processing device are configured to cause the processor to perform the following operations: receive a set of data repositories associated with a user wherein an individual data repository within the set comprises a dataset; consolidate datasets within the set of data repositories; calculate, via a web-based tool, a configuration from consolidated datasets based on predefined criteria configured by the user; and populate an interface using the configuration calculated from the web-based tool.

In some embodiments, the computer-readable code portions are further configured to recommend adjustment of datasets within the set of data repositories to align with predefined criteria.

In some embodiments, the computer-readable code portions are further configured to recommend adjustment of datasets within the set of data repositories via a resource exchange to align with predefined criteria.

In some embodiments, predefined criteria are adjustable by the user.

In some embodiments, the web-based tool at least partially utilizes a machine learning model to calculate the configuration.

In some embodiments, a plurality of configurations are calculated via the web-based tool based on predefined criteria configured by the user.

In some embodiments, predefined criteria are updated on a predetermined schedule.

In another aspect, a computer-implemented method for consolidation and analysis of data repositories via a web-based tool to automate contribution mechanisms is presented. The computer-implemented method comprising: receiving a set of data repositories associated with a user wherein an individual data repository within the set comprises a dataset; consolidating datasets within the set of data repositories; calculating, via a web-based tool, a configuration from consolidated datasets based on predefined criteria configured by the user; and populating an interface using the configuration calculated from the web-based tool.

In some embodiments, the computer-implemented method further comprises recommending adjustment of datasets within the set of data repositories to align with predefined criteria.

In some embodiments, the computer-implemented method further comprises recommending adjustment of datasets within the set of data repositories via a resource exchange to align with predefined criteria.

In some embodiments, the web-based tool at least partially utilizes a machine learning model to calculate the configuration.

In some embodiments, a plurality of configurations are calculated via the web-based tool based on predefined criteria configured by the user.

In some embodiments, predefined criteria are updated on a predetermined schedule.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrate technical components of an exemplary distributed computing environment for consolidation and analysis of data repositories via a web-based tool to automate contribution mechanisms, in accordance with an embodiment of the disclosure;

FIG. 2 illustrates an exemplary machine learning (ML) subsystem architecture, in accordance with an embodiment of the disclosure; and

FIG. 3 illustrates a process flow for consolidation and analysis of data repositories via a web-based tool to automate contribution mechanisms, in accordance with an embodiment of the disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, this data may be related to the people who work for the organization, its products or services, the customers, or any other aspect of the operations of the organization. As such, the entity may be any institution, group, association, financial institution, establishment, company, union, authority, or the like, employing information technology resources for processing large amounts of data.

As described herein, a “user” may be an individual associated with an entity. As such, in some embodiments, the user may be an individual having past relationships, current relationships, or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface may include a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, “authentication credentials” may be any information that may be used to identify a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure, and positioning (e.g., distal phalanges, intermediate phalanges, proximal phalanges, and the like)), an answer to a security question, a unique intrinsic user activity (e.g., making a predefined motion with a user device), and/or the like. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources input by the plurality of users within the system. The system may further use its authentication servers to certify the identity of users of the system, such that other users may verify the identity of the certified users. In some embodiments, the entity may certify the identity of the other users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (e.g., rotationally coupled, pivotally coupled, or the like). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

As used herein, a “resource” may generally refer to objects, products, devices, goods, commodities, services, and the like, and/or the ability and opportunity to access and use the same. Some example implementations herein contemplate property held by a user, including property that is stored and/or maintained by a third-party entity. In some example implementations, a resource may be associated with one or more accounts or may be property that is not associated with a specific account. Examples of resources associated with accounts may be accounts that have cash or cash equivalents, commodities, and/or accounts that are funded with or contain property, such as safety deposit boxes containing jewelry, art or other valuables, a trust account that is funded with property, or the like. For purposes of this disclosure, a resource is typically stored in a resource repository—a storage location where one or more resources are organized, stored, and retrieved electronically using a computing device.

As used herein, a “resource transfer,” “resource distribution,” or “resource allocation” may refer to any transactions, activities, or communications between one or more entities, or between the user and the one or more entities. A resource transfer may refer to any distribution of resources such as, but not limited to, a payment, processing of funds, purchase of goods or services, a return of goods or services, a payment transaction, a credit transaction, or other interactions involving a user's resource or account. Unless specifically limited by the context, a “resource transfer” a “transaction”, “transaction event” or “point of transaction event” may refer to any activity between a user, a merchant, an entity, or any combination thereof. In some embodiments, a resource transfer or transaction may refer to financial transactions involving direct or indirect movement of funds through traditional paper transaction processing systems (e.g., paper check processing) or through electronic transaction processing systems. Typical financial transactions include point of sale (POS) transactions, automated teller machine (ATM) transactions, person-to-person (P2P) transfers, internet transactions, online shopping, electronic funds transfers between accounts, transactions with a financial institution teller, personal checks, conducting purchases using loyalty/rewards points, etc. When discussing that resource transfers or transactions are evaluated, it could mean that the transaction has already occurred, is in the process of occurring or being processed, or that the transaction has yet to be processed/posted by one or more financial institutions. In some embodiments, a resource transfer or transaction may refer to non-financial activities of the user. In this regard, the transaction may be a customer account event, such as but not limited to the customer changing a password, ordering new checks, adding new accounts, opening new accounts, adding or modifying account parameters/restrictions, modifying a payee list associated with one or more accounts, setting up automatic payments, performing/modifying authentication procedures and/or credentials, and the like.

As used herein, “payment instrument” may refer to an electronic payment vehicle, such as an electronic credit or debit card. The payment instrument may not be a “card” at all and may instead be account identifying information stored electronically in a user device, such as payment credentials or tokens/aliases associated with a digital wallet, or account identifiers stored by a mobile application.

Datasets within data repositories may be consolidated and analyzed to calculate an output associated with a contribution mechanism. The distribution and arrangement of datasets may act as an input that results in a configuration which may be judged according to predefined criteria. The complexity of multiple datasets, entering data, and analyzing the resulting output may invite a plurality of issues.

Multiple data repositories (e.g., resource accounts, portfolios, resource positions, etc.,) may be difficult to analyze and control when using datasets as inputs. Moreover, manually inputting datasets from the multiple data repositories may produce anomalies due to incorrect or faulty data. Manual entrance of the datasets may further be a time consuming and wasteful endeavor. Further still, outputs from the entered inputs may create an output or outcome that may not align with a preferred configuration.

The multiple data repositories may be received and analyzed to predict/calculate the output from the arrangement and configuration of datasets within the repositories. The configured output may be constructed to align with predefined criteria according to a user (e.g., the data is arranged and exchanged to generate the lowest output possible). Upon calculation of the configuration, an interface may be populated using values according to the datasets from the data repositories. In other words, fields may be filled in automatically using datasets from multiple sources to facilitate data entry and reduce the appearance of anomalies within the interface.

Accordingly, the present disclosure describes consolidating and analyzing data repositories via a web-based tool to automate contribution mechanisms. Received data repositories and the datasets within may be consolidated and used to create a configuration in line with predefined criteria dictated by a user. An interface associated with contribution mechanisms may then be populated using the calculated data and a web-based tool to reflect the predefined criteria. Configurations may be adjusted by the user, and by recommendations of the web-based tool. The web-based tool may recommend datasets within the data repository may be adjusted by additional data exchanges, including physical resource exchanges. Machine learning models and artificial intelligence may be used at least partially by the web-based tool to assess and calculate the configuration and assess options in changing datasets to generate different outputs. Predefined criteria may be adjusted by the user associated with the set of data repositories, and the web-based tool upon conclusion of calculations.

What is more, the present disclosure provides a technical solution to a technical problem. As described herein, the technical problem includes consolidation and analysis of data repositories via a web-based tool. The technical solution presented herein allows for calculation and determination of a configuration while adaptable to the received data repositories. In particular, consolidation and analysis of data repositories via a web-based tool is an improvement over existing solutions to the manual input of data from repositories while determining configuration, (i) with fewer steps to achieve the solution, thus reducing the amount of computing resources, such as processing resources, storage resources, network resources, and/or the like, that are being used, (ii) providing a more accurate solution to problem, thus reducing the number of resources required to remedy any errors made due to a less accurate solution, (iii) removing manual input and waste from the implementation of the solution, thus improving speed and efficiency of the process and conserving computing resources, (iv) determining an optimal amount of resources that need to be used to implement the solution, thus reducing network traffic and load on existing computing resources. Furthermore, the technical solution described herein uses a rigorous, computerized process to perform specific tasks and/or activities that were not previously performed. In specific implementations, the technical solution bypasses a series of steps previously implemented, thus further conserving computing resources.

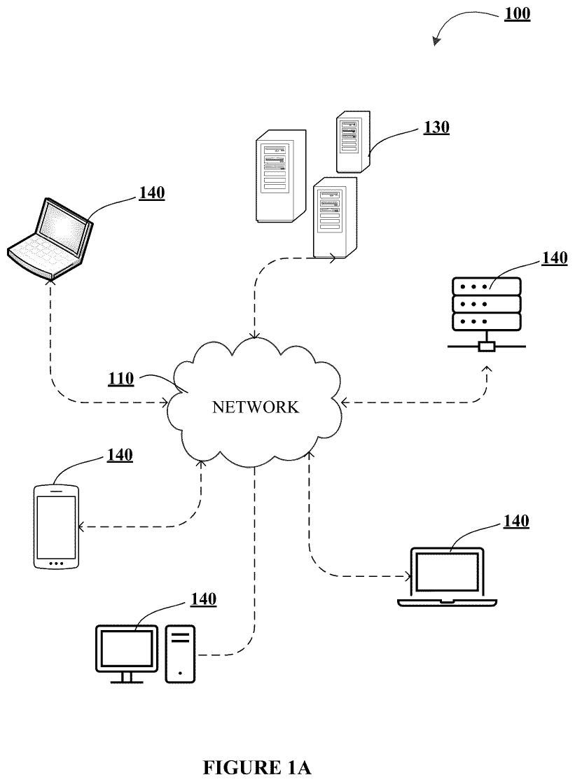

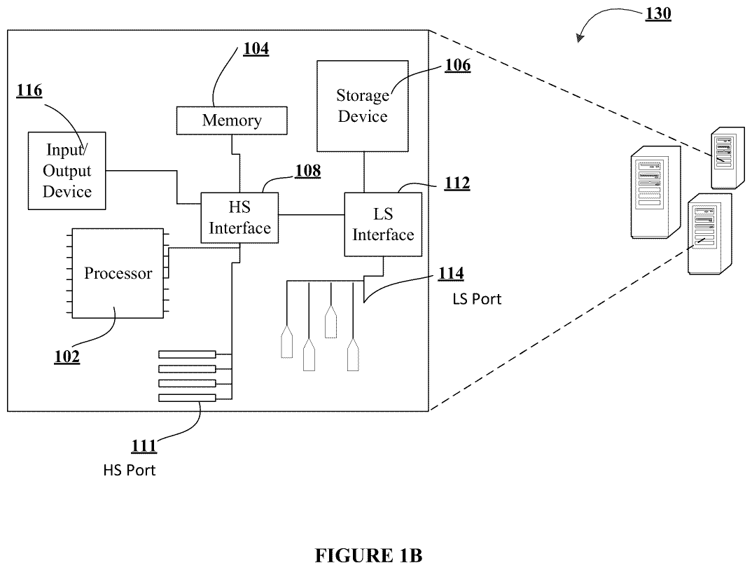

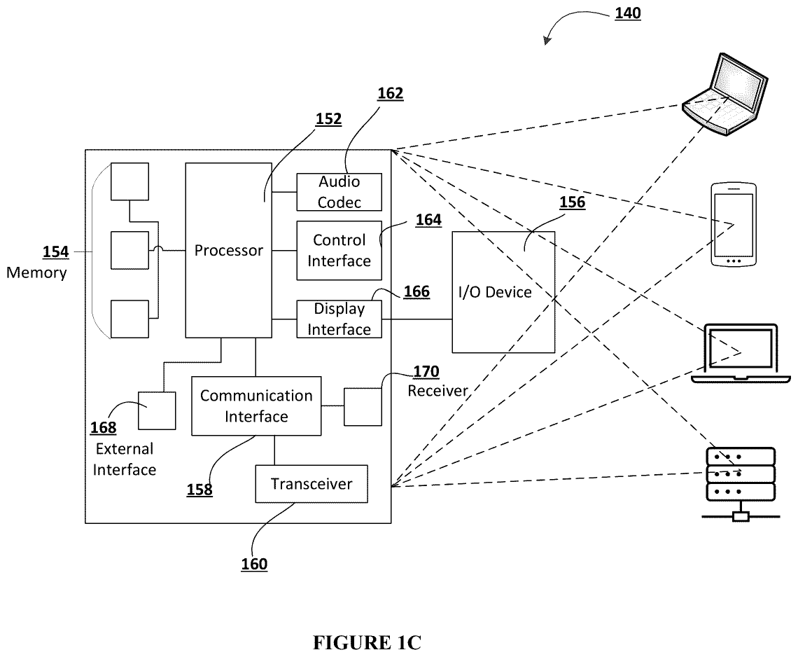

FIGS. 1A-1C illustrate technical components of an exemplary distributed computing environment for consolidation and analysis of data repositories via a web-based tool to automate contribution mechanisms 100, in accordance with an embodiment of the disclosure. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connected to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, entertainment consoles, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which may be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the disclosure. As shown in FIG. 1B, the system 130 may include a processor 102, memory 104, input/output (I/O) device 116, and a storage device 106. The system 130 may also include a high-speed interface 108 connecting to the memory 104, and a low-speed interface 112 connecting to low-speed bus 114 and storage device 106. Each of the components 102, 104, 106, 108, 112 and 114 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 106, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product may be tangibly embodied in an information carrier. The computer program product may also contain instructions that, when executed, perform one or more methods, such as those described above. The information carrier may be a non-transitory computer- or machine-readable storage medium, such as the memory 104, the storage device 106, or memory on processor 102.

The high-speed interface 108 manages bandwidth-intensive operations for the system 130, while the low-speed interface/controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, the low-speed interface/controller 112 is coupled to storage device 106 and low-speed bus/expansion port 114. The low-speed bus/expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, the system 130 may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor 152 may be implemented as a chipset of chips that include separate and multiple analog and digital processors. The processor 152 may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 166 may comprise appropriate circuitry and may be configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 may be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier may be a computer- or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through the communication interface 158, which may include digital signal processing circuitry where necessary. The communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, a GPS (Global Positioning System) receiver module 170 may provide additional navigation and location-related wireless data to end-point device(s) 140, which may be used as appropriate by applications running thereon, and in some embodiments, one or more applications operating on the system 130.

The end-point device(s) 140 may also communicate audibly using an audio codec 162, which may receive spoken information from a user and convert the spoken information to usable digital information. The audio codec 162 may likewise generate audible sound for a user, such as through a speaker (e.g., in a handset of end-point device(s) 140). Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described herein may be realized in digital electronic circuitry, integrated circuitry, specially designed ASICs (application specific integrated circuits), computer hardware, firmware, software, and/or combinations thereof.

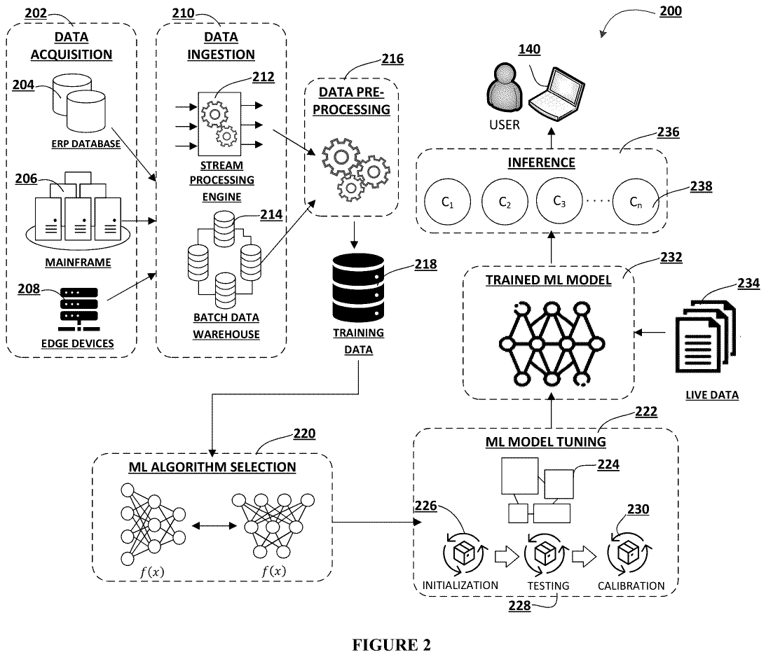

FIG. 2 illustrates an exemplary architecture of a machine learning (ML) subsystem 200, in accordance with an embodiment of the disclosure. The machine learning subsystem 200 may include a data acquisition engine 202, data ingestion engine 210, data pre-processing engine 216, ML model tuning engine 222, and inference engine 236.

The data acquisition engine 202 may identify various internal and/or external data sources to generate, test, and/or integrate new features for training the machine learning model 224. These internal and/or external data sources 204, 206, and 208 may be initial locations where the data originates or where physical information is first digitized. The data acquisition engine 202 may identify the location of the data and may describe connection characteristics for access and retrieval of data. In some embodiments, data is transported from each data source 204, 206, or 208 using any applicable network protocols, such as the File Transfer Protocol (FTP), Hyper-Text Transfer Protocol (HTTP), or any of the myriad of Application Programming Interfaces (APIs) provided by websites, networked applications, and other services. In some embodiments, the these data sources 204, 206, and 208 may include Enterprise Resource Planning (ERP) databases that host data related to day-to-day business activities such as accounting, procurement, project management, exposure management, supply chain operations, and/or the like, mainframes that are often the entity's central data processing center, edge devices that may be any piece of hardware, such as sensors, actuators, gadgets, appliances, or machines, that may be programmed for certain applications and may transmit data over the internet or other networks, and/or the like. The data acquired by the data acquisition engine 202 from the se data sources 204, 206, and 208 may then be transported to the data ingestion engine 210 for further processing.

Depending on the nature of the data imported from the data acquisition engine 202, the data ingestion engine 210 may move the data to a destination for storage or further analysis. Typically, the data imported from the data acquisition engine 202 may be in varying formats as they come from different sources, including RDBMS, other types of databases, S3 buckets, CSVs, or from streams. Since the data comes from different locations, the data may need to be cleansed and transformed so that it may be analyzed together with data from other sources. At the data ingestion engine 210, the data may be ingested in real-time, using the stream processing engine 212, in batches using the batch data warehouse 214, or in a combination of both. The stream processing engine 212 may be used to process continuous data streams (e.g., data from edge devices) by computing on data directly as it is received, and filtering the incoming data to retain specific portions that are deemed useful by aggregating, analyzing, transforming, and/or ingesting the data. On the other hand, the batch data warehouse 214 may collect and transfer data in batches according to scheduled intervals, triggered events, and/or any other logical ordering.

In machine learning, the quality of data and the useful information that may be derived therefrom, directly affects the ability of the machine learning model 224 to learn. The data pre-processing engine 216 may implement advanced integration and processing steps needed to prepare the data for machine learning execution. This may include modules to perform any upfront data transformations to consolidate the data into alternate forms by changing the value, structure, and/or format of the data by using generalization, normalization, attribute selection, and aggregation, to data clean by filling missing values, smoothing noisy data, resolving inconsistent data, removing outliers, and/or any other encoding steps as needed.

In addition to improving the quality of the data, the data pre-processing engine 216 may implement feature extraction and/or selection techniques to generate training data 218. Feature extraction and/or selection is a process of transforming and/or reducing the data into new features that may better represent underlying patterns in the data. Additionally, or alternatively, feature extraction and/or selection may be a process of dimensionality reduction by which an initial set of data is reduced to more manageable groups for processing. A characteristic of these large data sets is a large number of variables that require a lot of computing resources to process. Feature extraction and/or selection may be used to select and/or com bine variables into features, effectively reducing the amount of data that must be processed, while still accurately and completely describing the original data set. Depending on the type of machine learning algorithm being used, this training data 218 may require further enrichment. For example, in supervised learning, the training data may be enriched using one or more meaningful and informative labels to provide context such that a machine learning model may learn from the provided context. For example, labels may indicate whether a photo contains a bird or a car, which words were uttered in an audio recording, or if an x-ray contains a tumor. Data labeling is required for a variety of use cases including computer vision, natural language processing, and speech recognition. In contrast, unsupervised learning may use unlabeled data to find patterns in the data, such as inferences or clustering of data points.

The ML model tuning engine 222 may be used to train a machine learning model 224 using the training data 218 to make predictions or decisions without explicitly being programmed to do so. The machine learning model 224 represents what was learned by the selected machine learning algorithm 220 and represents the rules, numbers, and any other algorithm-specific data structures required for classification. Selecting the right machine learning algorithm may depend on a number of different factors, such as the problem statement and the kind of output needed, the type and the size of the data, the available computational time, the number of features and observations in the data, and/or the like. Machine learning algorithms may refer to programs (e.g., math and logic) that may be configured to self-adjust and perform better as they are exposed to more data. To this extent, machine learning algorithms are capable of adjusting their own parameters, given feedback on previous performance in making prediction about a dataset.

The machine learning algorithms contemplated, described, and/or used herein include supervised learning (e.g., using logistic regression, using back propagation neural networks, using random forests, decision trees, or the like), unsupervised learning (e.g., using an Apriori algorithm, using K-means clustering), semi-supervised learning, reinforcement learning (e.g., using a Q-learning algorithm, using temporal difference learning), and/or any other suitable machine learning model type. Each of these types of machine learning algorithms can implement any of one or more of a regression algorithm (e.g., ordinary least squares, logistic regression, stepwise regression, multivariate adaptive regression splines, locally estimated scatterplot smoothing, or the like), an instance-based method (e.g., k-nearest neighbor, learning vector quantization, self-organizing map, or the like), a regularization method (e.g., ridge regression, least absolute shrinkage and selection operator, elastic net, or the like), a decision tree learning method (e.g., classification and regression tree, iterative dichotomiser 3, C4.5, chi-squared automatic interaction detection, decision stump, random forest, multivariate adaptive regression splines, gradient boosting machines, or the like), a Bayesian method (e.g., naïve Bayes, averaged one-dependence estimators, Bayesian belief network, or the like), a kernel method (e.g., a support vector machine, a radial basis function, or the like), a clustering method (e.g., k-means clustering, expectation maximization, or the like), an associated rule learning algorithm (e.g., an Apriori algorithm, an Eclat algorithm, or the like), an artificial neural network model (e.g., a Perceptron method, a back-propagation method, a Hopfield network method, a self-organizing map method, a learning vector quantization method, or the like), a deep learning algorithm (e.g., a restricted Boltzmann machine, a deep belief network method, a convolution network method, a stacked auto-encoder method, or the like), a dimensionality reduction method (e.g., principal component analysis, partial least squares regression, Sammon mapping, multidimensional scaling, projection pursuit, or the like), an ensemble method (e.g., boosting, bootstrapped aggregation, AdaBoost, stacked generalization, gradient boosting machine method, random forest method, or the like), and/or the like.

To tune the machine learning model, the ML model tuning engine 222 may repeatedly execute cycles of experimentation including initialization 226, testing 228, and/or calibration 230 to optimize the performance of the machine learning algorithm 220 and refine the results in preparation for deployment of those results for consumption or decision making. To this end, the ML model tuning engine 222 may dynamically vary hyperparameters each iteration (e.g., number of trees in a tree-based algorithm or the value of alpha in a linear algorithm), run the algorithm on the data again, then compare its performance on a validation set to determine which set of hyperparameters results in the most accurate model. The accuracy of the model is the measurement used to determine which set of hyperparameters is best at identifying relationships and patterns between variables in a dataset based on the input, or training data 218. A fully trained machine learning model 232 is one whose hyperparameters are tuned and whose model accuracy is maximized.

The trained machine learning model 232, similar to any other software application output, may be persisted to storage, file, memory, or application, or looped back into the processing component to be reprocessed. More often, the trained machine learning model 232 is deployed into an existing production environment to make practical business decisions based on live data 234. To this end, the machine learning subsystem 200 uses the inference engine 236 to make such decisions. The type of decision-making may depend upon the type of machine learning algorithm used. For example, machine learning models trained using supervised learning algorithms may be used to structure computations in terms of categorized outputs (e.g., C₁, C₂, . . . , Cₙ 238) or observations based on defined classifications, represent possible solutions to a decision based on certain conditions, model complex relationships between inputs and outputs to find patterns in data or capture a statistical structure among variables with unknown relationships, and/or the like. On the other hand, machine learning models trained using unsupervised learning algorithms may be used to group (e.g., C₁, C₂, . . . , Cₙ 238) live data 234 based on how similar they are to one another to solve exploratory challenges where little may be known about the data, provide a description or label (e.g., C₁, C₂, . . . , Cₙ 238) to live data 234, such as in classification, and/or the like. These categorized outputs, groups (clusters), or labels may then be presented to the user input system 140. In still other cases, machine learning models that perform regression techniques may use live data 234 to predict or forecast continuous outcomes.

It will be understood that the embodiment of the machine learning subsystem 200 illustrated in FIG. 2 is exemplary and that other embodiments may vary. As another example, in some embodiments, the machine learning subsystem 200 may include more, fewer, or different components.

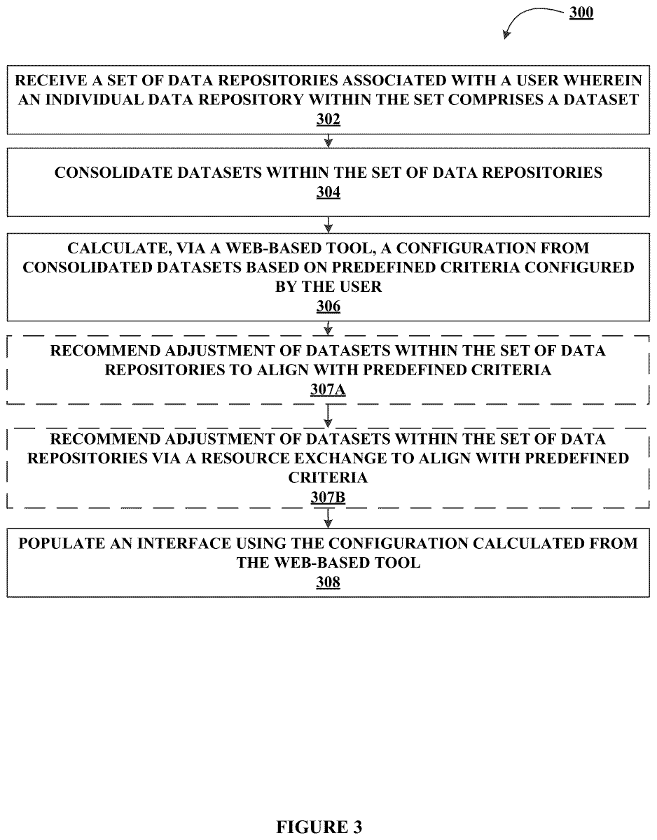

FIG. 3 illustrates a process flow for consolidation and analysis of data repositories via a web-based tool to automate contribution mechanisms. In some embodiments, a system (e.g., similar to one or more of the systems described herein with respect to FIGS. 1A-1C) and a form of machine learning (e.g., similar to one or more exemplary machine learning subsystem architectures described herein with respect to FIG. 2) may perform one or more of the steps of process flow 300.

As shown in Block 302, the process flow 300 may include the step of receiving a set of data repositories associated with a user wherein an individual data repository within the set comprises a dataset. A data repository as described herein may refer to a system, database, storage medium, and/or structure that may at least partially maintain financial, transactional, and/or resource-related data. A data repository may include, but may not be limited to, accounts, resource portfolios, strategic planning accounts, resource accounts, real estate holdings, digital resources, financial statements, and/or resource related information associated with a user. The data repository may be a centralized or distributed system and may be maintained by an entity, third party data aggregators, cloud storage providers, enterprise management systems, and/or an entity that may be associated with relevant resource data attributed to the user. The data repository may further store historical data, real time updates, predictive models, and/or structured or unstructured resource-based data that may be analyzed by the web-based tool. In some embodiments, the web-based tool may access one or more data repositories via secure application programming interfaces (APIs), direct database queries, encrypted file transfers, machine learning models, and/or other methods of data retrieval to collect, analyze, and generate insights from the user's resource associated information.

A user associated with the set of data repositories may be an individual, group, entity, and/or combination that may have authorized access to one or more data repositories. A user may maintain or interact with resource related and/or exchange data. A user may directly control the data repositories or may be granted access through third-party services, data aggregators, and/or institutional partnerships. The user may interact with the system through a graphical user interface (GUI), an application programming interface (API), or other digital means. The user may configure settings, view reports, set preferences, and/or apply analytical models to datasets within the data repositories.

Datasets within data repositories may include but may not be limited to repository information (e.g., balances, exchange history, account types, account holder details), resource data (e.g., resource holdings, resource allocations, historical performances and exposure assessments), compliance data, predictive and analytic data. Datasets may be processed and normalized via the web-based tool to create a comprehensive background for analysis. The web-based tool may analyze datasets within data repositories to detect patterns, anomalies, and/or optimizations opportunities within the analyzed consolidated data, as described in greater detail below.

As shown in Block 304, the process flow 300 may include the step of consolidating datasets within the set of data repositories. Consolidation of the datasets may comprise assessing datasets within the set of data repositories. For instance, datasets from multiple data repositories may be combined, subtracted, compared, and/or used in predetermined calculations/algorithms. The datasets within the multiple data repositories may be consolidated and combined via a web-based tool, as described in greater detail below.

The web-based tool may consolidate, process, analyze, and/or calculate datasets from a plurality of data repositories associated with a user. The web-based tool may be configured to retrieve and aggregate data from financial, resource based, and exchange-based sources, and may provide a comprehensive analysis of accounts, resources, and goals associated with the user. In some embodiments, the web-based tool may be an interactive platform accessible via a web browser and/or dedicated application. The web-based tool may enable links, views, and management of data repositories through a unified interface. Datasets from the data repositories may be retrieved in real time via the web-based tool, which may be conducted at scheduled intervals, or upon request (by the user and/or an authorized third party) via secure communication protocols. Communication protocols may include but may not be limited to APIs, encrypted data transfers, and/or means of data synchronization. The web-based tool may enable users to retrieve, consolidate, and analyze data from these repositories, facilitating insights, configuration calculations, and/or decision-making processes based on available information.

In some embodiments, the web-based tool may at least partially utilize a machine learning model to consolidate datasets and/or calculate the configuration. Parts of the exemplary machine learning subsystem architecture as described in FIG. 2 may be utilized by the web-based tool to conduct consolidation and/or calculation procedures. The machine learning model utilized within the web-based tool may be trained using data gathered from previously encountered data repositories, datasets, predefined criteria, and configurations. The machine learning model may be utilized to enhance data analysis, predictive modeling, and configuration augmentation. The machine learning model may be applied to dynamically adjust predefined criteria, predict configurations, and/or recommend adjustments that align user-defined objectives. The machine learning model may utilize supervised learning models trained on labeled datasets, unsupervised learning techniques to detect anomalies or clustering patters, or reinforcement learning to iteratively refine configurations. Additionally, machine learning models may be used to automate the selection of configurations based on predefined objectives.

As shown in Block 306, the process flow 300 may include the step of calculating, via a web-based tool, a configuration from consolidated datasets based on predefined criteria configured by the user. A configuration may refer to an arrangement or allocation of data within defined fields, determined based on information retrieved from one or more data repositories. A configuration may be derived by assigning quantitative inputs to multiple parameters, optimizing these inputs according to predefined criteria, and generating an output that meets a predetermined objective. For instance, quantitative inputs may be assigned from data repositories to generate the lowest output. Datasets within the data repositories may be adjusted accordingly to generate the lowest output. In another instance, the configuration may be derived by calculating the lowest output when combined with movement/transfer of data within the data repositories and resources exchanges, as described in greater detail below. Configurations may be dynamically generated through computational analysis of various datasets, where different field assignments are evaluated to determine an output aligning with the predefined criteria. The configuration may be determined via algorithms, heuristic models, and/or rule-based logic to assess multiple possible configurations and identify one or more arrangements that align with constraints, strategic goals, and/or objectives. A configuration may be adjusted iteratively in response to real-time updates, historical trends, predictive modeling, or user-defined preferences, to create a resulting arrangement that is continuously updated based on relevant data.

The predefined criteria may refer to calculating the smallest output using the inputs from the combination of datasets from the set of data repositories. For instance, inputs from datasets within the set of data repositories may form inputs, and the output may depend on the size and distribution of inputs. The predefined criteria may prioritize distribution of inputs across the set of data repositories and/or reduction of inputs to reduce the output.

As shown in Block 308, the process flow 300 may include the step of populating an interface using the configuration calculated from the web-based tool. Populating the interface may comprise arranging datasets from the consolidated data repositories to fields within the interface to align with the predefined criteria. In other words, populating the interface may arrange inputs from data repositories to align with the calculated configuration. In some embodiments, the interface may be part of a contribution mechanism which may facilitate the transfer of data/resources from the set of data repositories to a receiver. The contribution mechanism may be a distribution platform (e.g., charitable giving, resource donations, etc. ,) that may house the interface that may be populated.

In some embodiments, FIG. 3 illustrates an additional process flow for consolidation and analysis of data repositories via a web-based tool to automate contribution mechanisms. In some embodiments, as shown in Block 307A, the process flow 300 may include the step of recommending adjustment of datasets within the set of data repositories to align predefined criteria. Adjustment of datasets may change the calculated output from the web-based tool. In some embodiments, the web-based tool may compare the first configuration to a second configuration by recommending movement, exchanges, transfers, increases, and/or decreases within the set of data repositories to alter the output.

In some embodiments, as shown in Block 307B, the process flow 300 may include the step of recommending adjust of datasets within the set of data repositories via a resource exchange to align with predefined criteria. The resource exchange may comprise the movement of datasets within the set of data repositories via a physical exchange of resources. For instance, the recommendation may comprise adjusting the datasets within the set of data repositories via the performance of a resource exchange/movement which may alter the resulting output.

In some embodiments, the predefined criteria may be adjustable by the user. Upon calculation of the configuration, the user may adjust the predefined criteria to align with a secondary objective. For instance, the predefined criteria may be adjusted to move, manipulate, and/or allocate data from a first data repository over a second data repository within the set. In another instance, the predefined criteria may be adjusted based on attributes of the user (e.g., whether the predefined criteria are reflecting an individual user or a representative of a group or entity). In some embodiments, a plurality of configurations are calculated via the web-based tool based on predefined criteria configured by the user. The plurality of configurations may be calculated to test multiple outputs and may be compared. The plurality of configurations may be compared by the user, and may use different alterations, movements, allocations, and/or combinations of datasets within the set of data repositories.

In some embodiments, predefined criteria and/or configurations may be updated on a predetermined schedule. For instance, calculations associated with the configurations may be updated on a consistent time period (e.g., once an hour, a week, a month). In another instance, predefined criteria and/or configurations may be updated upon reception of a signal from the user. The predetermined schedule may be updated in fixed intervals, in response to events, in incremental updates, and/or upon reception of a notification/alert.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out the specialized operations of the present invention may be required on the specialized computer include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These computer-executable program code portions execute via the processor of the computer and/or other programmable data processing apparatus and create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

1. A system for consolidation and analysis of data repositories via a web-based tool to automate contribution mechanisms, the system comprising:
at least one non-transitory storage device; and
at least one processing device coupled to the at least one non-transitory storage device, wherein the at least one processing device is configured to:
receive a set of data repositories associated with a user wherein an individual data repository within the set comprises a dataset, wherein the dataset comprises user portfolio positions, and wherein the dataset further comprises repository information including balances, exchange history, and account types;
consolidate datasets within the set of data repositories;
calculate, via a web-based tool, a configuration from consolidated datasets based on predefined criteria configured by the user, wherein the predefined criteria comprises calculating a smallest output using inputs from the combination of datasets from the set of data repositories, wherein the configuration comprises an arrangement or allocation of data within defined fields;
populate an interface with a calculated output using the configuration calculated from the web-based tool, wherein the interface is part of a contribution mechanism configured to facilitate transfer of resources from the set of data repositories to a receiver; and
adjust the calculated output from the web-based tool iteratively in response to real-time updates via comparison of a first configuration to a second configuration based on movement, exchanges, and transfers within the consolidated datasets.

2. The system of claim 1, wherein the at least one processing device is further configured to recommend adjustment of datasets within the set of data repositories to align with predefined criteria.

3. The system of claim 2, wherein the at least one processing device is further configured to recommend adjustment of datasets within the set of data repositories via a resource exchange to align with predefined criteria.

4. The system of claim 1, wherein predefined criteria are adjustable by the user.

5. The system of claim 1, wherein the web-based tool at least partially utilizes a machine learning model to calculate the configuration.

6. The system of claim 1, wherein a plurality of configurations are calculated via the web-based tool based on predefined criteria configured by the user.

7. (canceled)

8. A computer program product for consolidation and analysis of data repositories via a web-based tool to automate contribution mechanisms, the computer program product comprising at least one non-transitory computer-readable medium having computer-readable program code portions embodied therein, the computer-readable program code portions being configured to:
receive a set of data repositories associated with a user wherein an individual data repository within the set comprises a dataset, wherein the dataset comprises user portfolio positions, and wherein the dataset further comprises repository information including balances, exchange history, and account types;
consolidate datasets within the set of data repositories;
calculate, via a web-based tool, a configuration from consolidated datasets based on predefined criteria configured by the user, wherein the predefined criteria comprises calculating a smallest output using inputs from the combination of datasets from the set of data repositories, wherein the configuration comprises an arrangement or allocation of data within defined fields;
populate an interface with a calculated output using the configuration calculated from the web-based tool, wherein the interface is part of a contribution mechanism configured to facilitate transfer of resources from the set of data repositories to a receiver; and
adjust the calculated output from the web-based tool iteratively in response to real-time updates via comparison of a first configuration to a second configuration based on movement, exchanges, and transfers within the consolidated datasets.

9. The computer program product of claim 8, wherein the computer-readable code portions are further configured to recommend adjustment of datasets within the set of data repositories to align with predefined criteria.

10. The computer program product of claim 9, wherein the computer-readable code portions are further configured to recommend adjustment of datasets within the set of data repositories via a resource exchange to align with predefined criteria.

11. The computer program product of claim 8, wherein predefined criteria are adjustable by the user.

12. The computer program product of claim 8, wherein the web-based tool at least partially utilizes a machine learning model to calculate the configuration.

13. The computer program product of claim 8, wherein a plurality of configurations are calculated via the web-based tool based on predefined criteria configured by the user.

14. (canceled)

15. A computer-implemented method for consolidation and analysis of data repositories via a web-based tool to automate contribution mechanisms, the computer-implemented method comprising:
receiving a set of data repositories associated with a user wherein an individual data repository within the set comprises a dataset, wherein the dataset comprises user portfolio positions, and wherein the dataset further comprises repository information including balances, exchange history, and account types;
consolidating datasets within the set of data repositories;
calculating, via a web-based tool, a configuration from consolidated datasets based on predefined criteria configured by the user, wherein the predefined criteria comprises calculating a smallest output using inputs from the combination of datasets from the set of data repositories. wherein the configuration comprises an arrangement or allocation of data within defined fields;
populating an interface with a calculated output using the configuration calculated from the web-based tool, wherein the interface is part of a contribution mechanism configured to facilitate transfer of resources from the set of data repositories to a receiver; and
adjusting the calculated output from the web-based tool iteratively in response to real-time updates via comparison of a first configuration to a second configuration based on movement, exchanges, and transfers within the consolidated datasets.

16. The computer-implemented method of claim 15, wherein the computer-implemented method further comprises recommending adjustment of datasets within the set of data repositories to align with predefined criteria.

17. The computer-implemented method of claim 16, wherein the computer-implemented method further comprises recommending adjustment of datasets within the set of data repositories via a resource exchange to align with predefined criteria.

18. The computer-implemented method of claim 15, wherein the web-based tool at least partially utilizes a machine learning model to calculate the configuration.

19. The computer-implemented method of claim 15, wherein a plurality of configurations are calculated via the web-based tool based on predefined criteria configured by the user.

20. (canceled)
